(19) United States
(12) Patent Application Publication
(10) Pub. No.: US 2007/0241893 A1
(43) Pub. Date: Oct. 18, 2007

(54) System for Protecting Against an Unauthorized Control of an a Environmentally Dangerous Production Process

(76) Inventor: Mikhail Yurievich Kudryavtsev, Moscow (RU)

Correspondence Address: PATENTTM.US, P. O. BOX 82788, PORTLAND, OR, 97282-0788, US

(21) Appl. No.: 11/573,698

(22) PCT Filed: Jun. 16, 2006
(86) PCT No.: PCT/RU06/00314

§ 371 Date: Feb. 14, 2007

(30) Foreign Application Priority Data
Jul. 5, 2005 (RU) 2005120792

(51) Int. Cl. G08B 29/00

(52) U.S. Cl. 340/540

(57) ABSTRACT

This invention relates to control systems for technological processes. A system for precluding unauthorized control of an environmentally hazardous technological process comprises means located in premises closed by doors and purposed to automatic stop of a technological process when preset critical parameter values defining hazard of a technological process are reached, the said premise doors being provided with locks comprising timers for delaying closing the doors for a time not less than 8 hours after the time of starting actions for opening them, and the said means for automatic stop of a technological process being provided with energy accumulators for powering the said means for automatic stop of a technological process for at least 8 hours. In the result the reliability of safe operation of a hazardous technological process is improved through precluding a possibility of transferring such technological process to an operation mode with reaching inadmissible parameter values defining hazard of the technological process at a given 8-hour time of subversive control of the technological process.

### FIELD OF THE INVENTION

This invention relates to systems providing a possibility of precluding environmentally hazardous situations causing human victims and pollution of the environment, and in particular to systems for control of an environmentally hazardous technological process, e.g., at a nuclear power station or a chemical production facility.

### PRIOR ART

A system for express diagnostics of emergencies is known, which comprises a system of photo sensors arranged at doorways in a building entrance, such sensors being arranged at several height levels and their lines of action being perpendicular and at certain angles to people movements in the entrance, “Emergency” buttons are located at staircases and elevators, combination locks and microphones being located on doors, car parameter code sensors being arranged with the possibility of recording their outputs to number-model, wherein the said sensors form their outputs from codes of people passing and codes of car parameters, record numbers-models into computer memory and into a host computer located in the operative response center, and when a man enters into the building entrance codes issued by a system of photo sensors, a voice message in a microphone, combination lock codes inputted by a man make records into computer memory as a number-model, the computer being capable of comparing a given number-model with the numbers-models stored in the computer and, after carrying out such comparison, issuing a signal if the number-model of a man in the building entrance is not stored in computer memory and sending the number-model to the operative response center (see RU N2 2138078, published on Sep. 20, 1999).

The above system provides for issuance an operative alarm signal, but it does not enable to preclude intruders from entering into guarded premises since it only fixes the fact that an alien person has entered the premises.

The closest to this invention as to the technical effect is a system for precluding control of an environmentally hazardous technological process, which comprises means for automatic stop of a technological process, where such means are located in premises closed by doors, and a technological process is stopped when preset critical values of parameters determining the hazard degree of such a technological process are reached (see a book by M. A. Shulz “Regulation of Nuclear Power Reactors”, translated from English, edited by D. I. Voskoboinik, M, Foreign Literature Publishing House, 1957, p. 386-395).

In the said system the means for automatic stop of a technological process may be disabled for a period of time which is lesser than the time of a working shift. Therefore, the said system makes it possible to achieve purpose of subversive control of a technological process in a case where the said means for automatic stop of technological process are disabled for the time which limits subversive control of a technological process, namely, the time of a working shift, after which subversive control of a technological process may be identified by external factors, e.g., by non-exit of workers completing their shift from premises where the technological process control means are located, by blocking such premises by intruders, and by other similar signs which cause anxiety and enable a rather big number of persons, e.g., external guards, conduct actions aimed at preventing a hazardous man-caused accident.

### BRIEF DESCRIPTION OF THE INVENTION

The technical effect which is achieved by this invention is to raise reliability of controlling a hazardous technological process in the safe operation mode by precluding the possibility of transferring the technological process to the critical operation mode and reaching inadmissible parameter values defining hazard of the technological process at a given time of subversive control of the technological process.

The said technical effect is achieved due to the fact that the inventive system for precluding unauthorized control of an environmentally hazardous technological process comprises means located in premises closed by doors and purposed to automatic stop of a technological process when preset critical parameter values defining hazard of a technological process are reached, the said premise doors being provided with locks comprising timers for delaying closing the doors for a time not less than 8 hours after the time of starting actions for opening them, and the said means for automatic stop of a technological process being provided with energy accumulators for powering the said means for automatic stop of a technological process for at least 8 hours.

The system may be provided with backup locks comprising timers and installed on the doors of the said premises for the purpose of alternatively checking the condition and working capacity of the said locks with timers and the backup locks with timers without opening the doors, and the means for automatic stop of a technological process may be provided with a system for regular checking the working capacity of the means for automatic stop of a technological process without stopping the technological process.

The means for automatic stop of a technological process may be provided with elements for autonomous stop of a technological process that are used when the said elements for automatic stop of a technological process are withdrawn.

Hazard of a technological process is a possibility of harmfully acting on the population, the environment and the personnel involved in the technological process. The state regulation of the activities relating to hazardous technological processes sets up admissible and inadmissible levels of technological process harmful influences corresponding to admissible and inadmissible parameter values defining hazard of a technological process. In accordance with technical regulations, means should be provided for automatic stop of a technological process if preset critical values of the parameters defining hazard of a technological process are reached in order to preclude inadmissible parameter values.

Hazardous technological processes are carried out at guarded facilities. Subversive control of a hazardous technological process, e.g., resulted from entering of a terrorist group into personnel accommodation spaces, is understood as a qualified action (e.g., personnel forced by terrorists who have captured personnel's families) on control means for a technological process for the purpose of reaching inadmissible parameter values defining hazard of a technological process. The facility guards may prevent subversive control if apparent signs of it are available to the guards. Therefore, time of subversive control of a technological process is limited to the moment of appearance of such signs.

An analysis of different subversive and terrorist attacks shows that a period of time equal to one working shift, which usually does not exceed 8 hours, is sufficient for identifying the fact of such a concealed attack. It is, therefore, important that during a preset time personnel involved into subversive control could not disable the means for automatic stop of a technological process. Opening doors before timer triggering is a break-in that is a sign of subversive control of a technological process, which is evident for the guards and which is followed by the guards intervention and termination of subversive control of a technological process. Therefore, an automatic stop of a technological process after reaching critical values of parameters defining hazard of a technological process will be ensured by means for automatic stop of a technological process, which maintain working capacity at subversive control of a technological process for a time limited to 8 hours.

If persons from a working shift are involved in a subversive act, signs evident for the guards may be personnel reports and signs identified by protective observation means, i.e., break-in of walls, doors, windows, hatches, open fire, smoke, vapor or increased radiation in premises, inadmissible changes in temperature or humidity in premises, damage to an alarm system.

In the most probable case subversive control of a technological process will be identified by personnel reporting at the time of taking over the shift. Terrorist compulsion of all the personnel to subversive control of a technological process is, in essence, an attack on the personnel accommodation spaces and is suppressed by the facility external guards. Thus, terrorist compulsion of a personnel shift to subversive control of a technological process should be considered as a single failure of a facility external guard system. A possibility of forcing the second successive personnel shift to subversive control of a technological process is much more difficult. Taking 8-hour time of a working shift as common, it means that only 8-hour time of subversive control of a technological process is possible.

Thus, automatic stop of a hazardous technological process at reaching preset admissible values of parameters defining hazard of that technological process in order not to allow such parameters to reach inadmissible values in a case of subversive control of that technological process, which is limited to 8 hours, is well justified.

In order to avoid disabling means for automatic stop of a technological process by switching off the power for the time, which subversive control of the technological process is limited to, the means for automatic stop of a technological process comprise energy accumulators for powering the means for automatic stop of a technological process for a given time.

In order to preclude using results of previous, time-limited subversive control (e.g., results of subversive modification of the means for automatic stop of a technological process during a repair of the means) during the next time-limited subversive control of a technological process it is necessary to check the condition and the working capacity of the said locks and timers as well as the working capacity of the means for automatic stop of a technological process after a given time corresponding to the time, which subversive control of the technological process is limited to. For this purpose the locks and the timers on each door of the premises may be backed up with the possibility of being alternatively checked for their condition and working capacity after a given time without opening the doors, and the means for automatic stop of a technological process may comprise elements for checking the working capacity of the means for automatic stop of a technological process after a given time without stopping the technological process.

In order to preclude a possibility of reaching inadmissible values of the parameters defining hazard of a technological process (which is the purpose of subversive control) during a repair of the means for automatic stop of the technological process, the means for automatic stop of a technological process may comprise elements for guaranteed stop of a technological process through controlled withdrawal of such elements.

So, the stated technical effect may be achieved in this way: improving the reliability of an environmentally hazardous technological process in the safe operation mode by precluding a possibility of transferring the technological process to an operation mode with reaching inadmissible values of the parameters defining hazard of the technological process at a given time of subversive control of the technological process.

### DESCRIPTION OF THE PREFERRED EMBODIMENT

The inventive system for precluding unauthorized control of an environmentally hazardous technological process comprises means located in premises closed by doors and purposed to automatic stop of a technological process when preset critical parameter values defining hazard of a technological process are reached, the said premise doors being provided with locks comprising timers for delaying closing the doors for a time not less than 8 hours after the time of starting actions for opening them, and the said means for automatic stop of a technological process being provided with energy accumulators for powering the said means for automatic stop of a technological process for at least 8 hours.

The system may be provided with backup locks comprising timers and installed on the doors of the said premises for the purpose of alternatively checking the condition and working capacity of the said locks with timers and the backup locks with timers without opening the doors, and the means for automatic stop of a technological process may be provided with a system for regular checking the working capacity of the means for automatic stop of a technological process without stopping the technological process.

The means for automatic stop of a technological process may be provided with elements for autonomous stop of a technological process that are used when the said elements for automatic stop of a technological process are withdrawn.

For the purpose of accessing (e.g., for carrying out repairs) the means for automatic stop of a technological process the technological process should be stopped, the locks on the doors of the corresponding premises should be opened, after the timer delay time expires the doors should be opened, and the elements without which the technological process is securely stopped should be temporarily withdrawn and removed to a place of controlled storage. After completing access the temporarily withdrawn elements should be returned to their design positions, the doors of the corresponding premises should be closed; the working capacity of the means for automatic stop of the technological process, the locks and the timers should be checked, and the technological process may be started.

The condition and the working capacity of the locks and the timers should be checked by alternatively unlocking the locks after a time corresponding the timer delay time and controlling the positions of the locks and the locking elements of the doors.

The working capacity of the means for automatic stop of a technological process should be checked as follows: sensor signals are imitated at which, according to the design, the corresponding working bodies, which determine the process, should move, and movements of the working bodies are controlled after imitating signals. In order to avoid stopping the technological process when checking the working capacity, signal imitation is stopped after the working bodies move to an insignificant part of their full travel. For checking the full travel of the working bodies the method of reciprocation may be used, which is used for check valves of steam turbines: working bodies operating in parallel are regularly moved in opposite directions, while maintaining their total action constant.

Depending on the design of sensors, signal imitation may be conducted either by direct action on sensor elements, or by generation of electric signals in parallel to sensors. Accordingly, any known mechanical, electro-mechanical or electrical devices may be used as imitating elements. Any known distant position indicators may be used as elements controlling positions of the working bodies.

During subversive control of a technological process the personnel involved in subversive control will attempt to disable the means for automatic stop of the technological process, since operative means for automatic stop of a technological process will not enable to achieve the goal of subversive control of the technological process. But during the time, which subversive control of the technological process is limited to, the personnel will not be able to get access to the means for automatic stop of the technological process.

### INDUSTRIAL APPLICABILITY

The present invention may be used in the nuclear power industry or the chemical industry for automatic stop of a technological process if preset critical values of the parameters, which define hazard of a technological process, are reached during time-limited subversive control of such technological process.

What is claimed is:

1. A system for precluding unauthorized control of an environmentally hazardous technological process comprises means located in premises closed by doors and purposed to automatic stop of a technological process when preset critical parameter values defining hazard of a technological process are reached, the said premise doors being provided with locks comprising timers for delaying closing the doors for a time not less than 8 hours after the time of starting actions for opening them, and the said means for automatic stop of a technological process being provided with energy accumulators for powering the said means for automatic stop of a technological process for at least 8 hours.

2. A system according to claim 1, characterized in that it is provided with backup locks comprising timers and installed on the doors of the said premises for the purpose of alternatively checking the condition and working capacity of the said locks with timers and the backup locks with timers without opening the doors, and the means for automatic stop of a technological process may be provided with a system for regular checking the working capacity of the means for automatic stop of a technological process without stopping the technological process.

3. A system according to claim 1, characterized in that the means for automatic stop of a technological process are provided with elements for autonomous stop of a technological process that are used when the said elements for automatic stop of a technological process are withdrawn.
